(19) United States
(12) Patent Application Publication
(10) Pub. No.: US 2004/0218591 A1
(43) Pub. Date: Nov. 4, 2004

(54) Bridge apparatus and methods of operation

(76) Inventors: Craig Ogawa, Loveland, CO (US); Craig Matthew Files, Fort Collins, CO (US)

Correspondence Address: Colorado vNet LLC, 266 East Sixth Street, Loveland, CO, 80537, US

(21) Appl. No.: 10/807,930

(22) Filed: Mar. 23, 2004

Related U.S. Application Data
(60) Provisional application No. 60/466,564, filed on Apr. 29, 2003.

(51) Int. Cl. H04L 12/28

(52) U.S. Cl. 370/364

(57) ABSTRACT

Implementations of bridges are described and claimed herein, e.g., for use in building automation systems. An exemplary implementation of a bridge for a building automation system comprises a system controller. A first network controller is operatively associated with the system controller to connect the bridge to a local area network. A second network controller is operatively associated with the system controller to connect the bridge to a subnetwork. Computer-readable program code is provided in computer-readable storage operatively associated with the system controller. The computer-readable program code includes: program code for receiving configuration information via the local area network; and program code for configuring an automation device connected to the subnetwork based on the configuration information.

### PRIORITY CLAIM

This application claims priority to co-owned U.S. Provisional Patent Application Ser. No. 60/466,564 for “BRIDGE APPARATUS AND METHODS OF OPERATION” of Craig Ogawa, filed Apr. 29, 2003, hereby incorporated herein for all that it discloses.

### TECHNICAL FIELD

The described subject matter relates to electronic computing, and more particularly to computer networking devices and methods.

### BACKGROUND

The ability to automatically control one or more functions in a building (e.g., lighting, heating, air conditioning, security systems) is known as building automation. Building automation systems may be used, for example, to automatically operate various lighting schemes in a house. Of course building automation systems may be used to control any of a wide variety of other functions, more or less elaborate than controlling lighting schemes.

Typically, each automation device (e.g., keypad, lighting control) is individually configured during installation. However, when automation devices are added or taken offline, a system administrator typically is required to come on-site to configure new devices and even reconfigure existing devices that are affected by the addition or removal of a device in the building automation system.

Alternatively, building automation systems may be controlled over a network by a central computer system (e.g., a server computer). However, if the central computer system fails, the entire building automation system may be unusable.

### SUMMARY

Exemplary implementations described and claimed herein provide a bridge for a building automation system. The bridge comprises a system controller. A first network controller is operatively associated with the system controller to connect the bridge to a local area network. A second network controller is operatively associated with the system controller to connect the bridge to a subnetwork. Computer-readable program code is provided in computer-readable storage operatively associated with the system controller. The computer-readable program code includes: program code for receiving configuration information via the local area network; and program code for configuring an automation device connected to the subnetwork based on the configuration information.

In another exemplary implementation, a building automation system comprises a local area network and a subnetwork for connecting at least one automation device. A first bridge connects the subnetwork to the local area network. A second bridge connects the subnetwork to the local area network. At least one of the bridges connects the subnetwork to the local area network even if the other bridge is offline.

In another exemplary implementation, a method is provided. The method may be implemented to connect a bridge to a local area network and connect the bridge to a subnetwork. Configuration information is received at the bridge via the local area network. An automation device in the subnetwork is configured based on the configuration information received at the bridge.

### BRIEF DESCRIPTION OF THE DRAWINGS

FIG. 1 is a schematic diagram showing exemplary bridge apparatus implemented in an automation network;

FIG. 2 is another schematic diagram showing exemplary bridge apparatus implemented in an automation network;

FIG. 3 is a block diagram illustrating exemplary functional components that may be implemented at a bridge apparatus;

FIG. 4 is a flow chart illustrating exemplary logical functions that may be implemented by a bridge apparatus; and

FIG. 5 is a schematic illustration of an exemplary computing device that can be utilized to implement logical functions of a bridge apparatus.

### DETAILED DESCRIPTION

An exemplary bridge apparatus may be implemented in a building automation system. Devices (e.g., on a Controller Area Network (CAN) bus) can be accessed for control and administration functions via other networks (e.g., an Ethernet network) using, e.g., a personal digital assistant (PDA), portable tablet, wall-mounted thin-film transistor (TFF) screen, or personal computer (PC). The bridge apparatus links the devices via a plurality of networks. The devices may also be used to access the other networks outside of the building automation system.

The bridge apparatus may be used, for example, by an installation technician using a laptop PC connected to the bridge apparatus to program and/or test automation devices in the building automation system. In another example, a user may use a PDA to connect to the bridge via a wireless Ethernet connection and send control signals to actuate a motor which closes the drapes inside the building (e.g., in one of the rooms). In yet another example, a homeowner can check the status of their home security system using a PC or a Web enabled appliance (e.g., mobile phone) connected to the bridge apparatus via the Internet. In still another example, a service technician may remotely access the bridge apparatus (e.g., from service headquarters) to download new firmware and/or diagnose a problem with the building automation system.

In one implementation, the bridge provides an Ethernet-to-CAN (E2C) connection, although it is noted that other networks, busses, and links are also contemplated (e.g., RS 232, RS 485). For the convenience of the reader, the control side of the bridge (e.g., CAN bus) is referred to herein as the C-Side while the Ethernet side of the bridge is referred to herein as the E-Side of the bridge. While the bridge provides access to the C-Side for administration and remote control, it may also be used to monitor and report system status, perform system diagnostics and perform recovery functions after a shutdown or interrupt.

An exemplary bridge apparatus may be manufactured at relatively low cost by using an embedded controller design. In addition, a plurality of bridges may be implemented as redundant or “shadow” bridges in a building automation system to reduce or altogether eliminate the occurrence of single-point failures. The bridge may also be installed as a standalone device or in readily available enclosures, such as a cabinet commercially-available from UStec (Victor, N.Y., 14564).

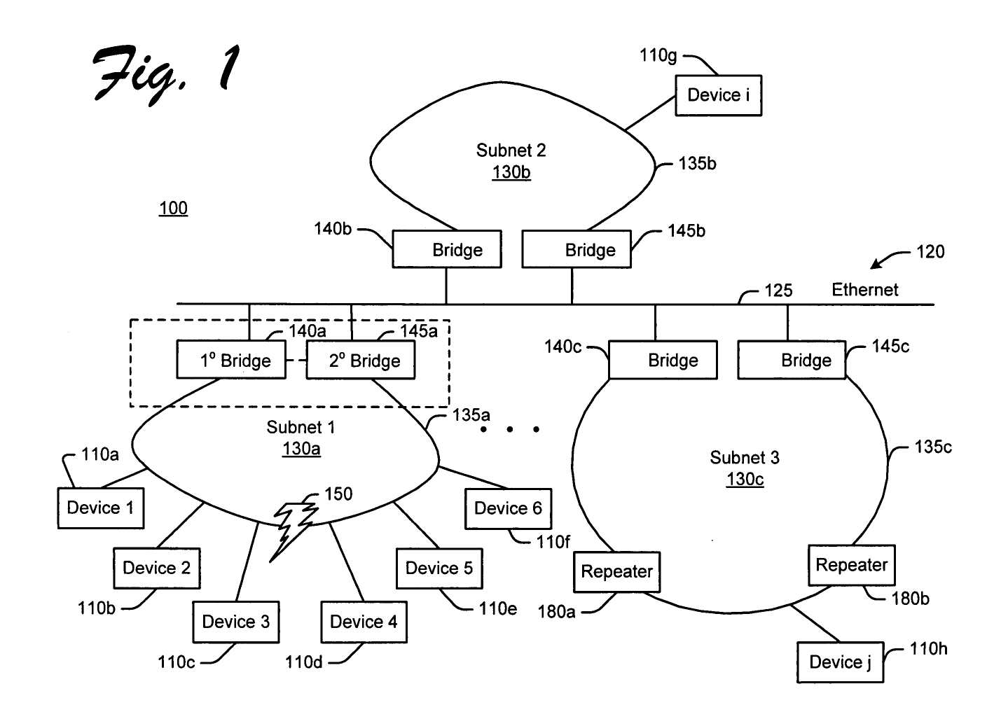

FIG. 1 is a schematic diagram showing an exemplary bridge apparatus as it may be implemented in an automation network, such as, e.g., a building automation system 100. Building automation systems are typically implemented to automate various functions in a home or other building (not shown). Exemplary functions may include lighting, heating, air conditioning, audio/visual output, operating window coverings to open/close, and security, to name only a few.

The building automation system 100 shown in FIG. 1 may comprise one or more devices 110a-h, such as control devices (e.g., keypads) and/or controlled devices (e.g., motors). The devices 110a-h (also generally referred to herein by reference 110) are communicatively coupled with one another over a network or a plurality of networks. For example, a local area network 120 may connect a plurality of subnetworks 130a, 130bg, 130c.

In an exemplary implementation, the devices are connected to at least one controller area network (CAN) bus 135a, 135b, 135c which are linked together by an Ethernet network 125, although other networks are also contemplated as being within the scope of the invention. Subnets may also include repeaters (e.g., 180a, 180b in subnet 130c) to extend the reach of the bus. Use of devices with a CAN bus are described in more detail in co-owned U.S. patent application Ser. No. 10/382,979, entitled “Building Automation System and Method” of Hesse, et al. filed on Mar. 5, 2003.

Briefly, the CAN bus may comprise a two-wire differential serial data bus. The CAN bus is capable of high-speed data transmission (about 1 Megabits per second (Mbits/s)) over a distance of about 40 meters (m), and can be extended to about 10,000 meters at transmission speeds of about 5 kilobits per second (kbits/s). It is also a robust bus and can be operated in noisy electrical environments while maintaining the integrity of the data.

It is noted that the building automation system 100 is not limited to any particular configuration or number of devices 110, and may comprise as many as 16,000 or more devices linked over extended runs throughout the building. The building automation system 100 also preferably comprises error handling and bus arbitration, enhancing its performance. The speed with which a number of (i.e., one or more) devices may send and receive signals over a single CAN bus is particularly advantageous for building automation (e.g., lights can be turned on and off immediately without recognizable delay). In addition, more than one CAN bus may be combined to extend the functionality of the building automation system. For example, a general purpose CAN bus may be provided for lighting and another CAN bus may be dedicated to the security system. The building automation system 100 may also be modified for different devices 110 and/or functions, even after the initial installation, allowing the building automation system 100 to be tailored to the user's preferences.

In operation, a control device (e.g., 110a) may issue command(s), which in turn instruct one or more of the controlled devices (e.g., 110d or 110g) to perform a function. By way of example, when a homeowner (or more generally, a user) presses a key on the keypad, the central lighting in the room may illuminate to a predetermined intensity (e.g., 50%) and perimeter lighting in the room may be turned on (e.g., at 100% intensity) to illuminate artwork hanging on the walls.

It should be understood that the foregoing example is provided in order to better understand one environment in which a building automation system 100 may be used. Of course the building automation system 100 may include any of a wide range of other types and configurations of devices 110, and can be used for functions which are now known or that may be developed in the future. The particular types of devices 110 and configurations of building automation system 100 may depend in part on design considerations, which can be readily defined and implemented by one having ordinary skill in the art after having become familiar with the teachings of the invention.

Continuing with reference to FIG. 1, the building automation system 100 may be configured with one or more CAN bus subnets (or “loops”) 130a, 130b, 130c. Each subnet 130a, 130b, 130c (also generally referred to herein by reference 130) includes one or more redundant bridges 140a-c, 145a-c (e.g., a primary bridge and a secondary or “shadow” bridge). The bridges 140a-c, 145a-c (generally referred to herein by references 140 and 145) link the subnets 130 to one another via an Ethernet LAN 125.

Redundant bridges 140, 145 may provide fault protection for the building automation system 100. By way of example, if a device 110 or connection to the device 110 is shorted or open (e.g., the line is broken), it does not shut the entire CAN bus loop 130. Instead, only the affected device 110 becomes unavailable. The redundant bridges 140, 145 still allow communication with each of the other devices 110 on the CAN bus loop 130. That is, traffic (e.g., data packets) in the subnetwork are rerouted.

In addition, each bridge 140, 145 may be provided with a copy of the operating information for the respective subnet 130 (e.g., device addresses, user preferences, scripts, firmware, etc.). If one of the bridges 140 (or 145) in a subnet fails, the redundant bridge 145 (or 140) may continue to operate each of the devices 110 on the CAN bus loop 130 so that the failure is transparent to the building owner. For example, the subnet 130 may automatically switch to the secondary bridge 145 if the primary bridge fails 140.

Redundant bridges 140, 145 may also be operated in a fault diagnostic mode. Each bridge 140, 145 may issue one or more diagnostic signals in the subnet 130 requesting a reply from devices 110 in the subnet 130. If a device 110 receives the diagnostic signal from the bridge 140, 145, the device 110 issues a reply signal to the bridge 140, 145. The reply signals may be used by the bridge 140, 145 to readily identify potential device failures. In addition, comparing the reply signals received at each bridge 140, 145 permits automatic diagnosis of a potential failure in the subnet 130 itself (e.g., a severed line illustrated by reference 150). For example, if the primary bridge 140a in subnet 130a receives reply signals from devices 110a-110c and the secondary bridge 145a received reply signals from devices 110d-110f, a comparison indicates that there is a potential failure between devices 110c and 110d in the subnet 130a.

If a subnet fault 150 is detected in the subnet 130, the redundant bridges 140, 145 may also be operated to reroute traffic or messages around the fault 150. For example where the fault 150 is between devices 110c and 100d, the primary bridge 140a may issue messages to devices 110a-110c, and the secondary bridge 145a may issue messages to devices 110d-110f.

The bridge apparatus 140, 145 may also be used to notify a user or system administrator of a failure or potential failure. System failures and warnings may be sent via email and/or displayed (e.g., on a PC monitor).

Bridge apparatus 140, 145 are not limited to primary/secondary configurations. In another exemplary implementation, a separate bridge apparatus 140, 145 may also be provided for separate functions. For example, a bridge may be provided to monitor the weather and adjust the thermostat, while another bridge may be provided for the security system. The bridges may be linked together, and even provided in one utility box.

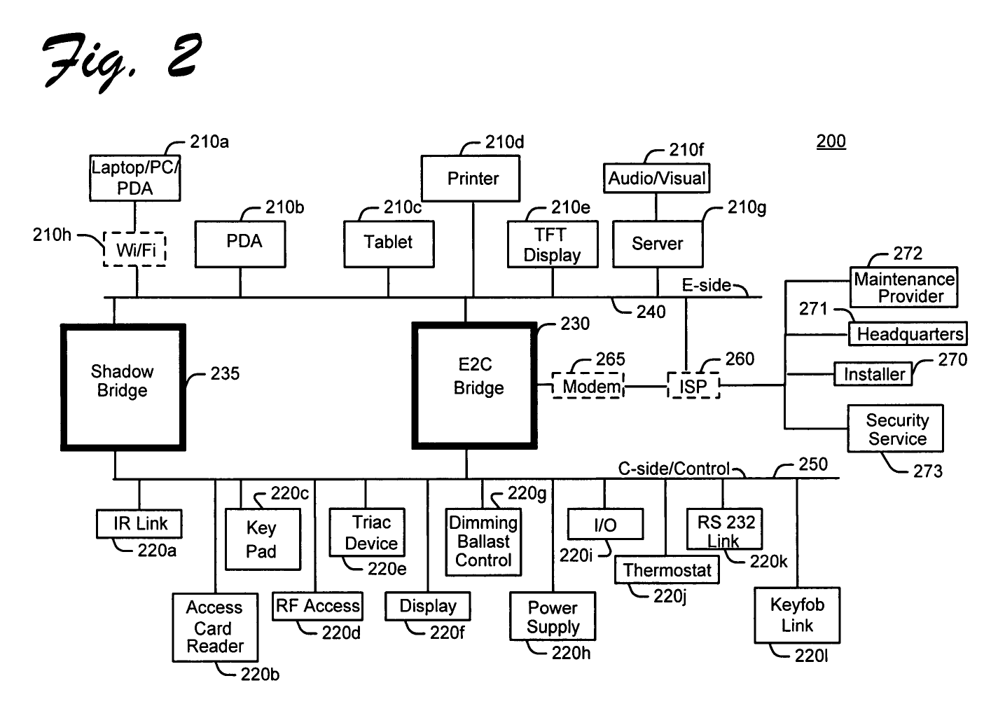

FIG. 2 is another schematic diagram showing an exemplary bridge apparatus as it may be implemented in an automation network (e.g., a building automation system 200). Automation devices 210a-h are shown in FIG. 2 connected to the E-side, such as a PDA, PC, laptop computer, tablet, printer, TFT display, server (e.g., for audio/visual content distribution and control), to name only a few exemplary devices. Automation devices 220a-l are also shown connected to the C-side, such as keypads, lighting controls (e.g., triac devices), displays (e.g., for graphical content, weather data, security video, etc.), a thermostat, to name only a few exemplary devices. Yet other automation devices (and/or links) 210, 220 not shown may also be used, as will be readily appreciated by one skilled in the art after having become familiar with the teachings of the invention. Suitable device drivers (e.g., for the printer) may be provided via the PC, laptop, server, or may be provided at the bridge apparatus 230, 235.

Bridge apparatus 230, 235 may be operated, for example, to provide access to digital media (e.g., stored at a server connected to the E-side 240) via controls on the C-side 250 (e.g., via a suitable audio amplifier). As another illustration, bridge apparatus 230, 235 may be operated to configure/reconfigure devices on the C-side 250. The configuration/reconfiguration may be stored at the bridge 230, 235 for operations. In addition, the bridge apparatus 230, 235 may send print commands to a printer 210d to print labels for keypads 220c when a device (e.g., Thermostat 220j) controlled by the keypad 220c is configured/reconfigured. The printer 210d may also be accessed by a system administrator via a remote link, e.g., to print labels for keypads 220c.

Bridge apparatus 230, 235 may also be implemented to be remotely accessed, for example, via an ISP 260. Remote access may occur via a modem 265 operatively associated with the bridge 230, or via the Ethernet (E-side) 240, or other suitable link.

Optionally, bridge apparatus 230, 235 may include an integrated modem or other communications device, although an external communications device may also be provided. The communications device may be used by the bridge 230, 235 to establish an outside network connection, for example, if the bridge 230, 235 is unable to otherwise establish a connection (e.g., via the Ethernet port). For example, the bridge 230, 235 may query service headquarters at various intervals (e.g., daily, weekly, etc.) for program code updates and downloads.

The communications device 265 may also be used to establish an incoming link with the bridge 230, 235 for performing tasks such as, but not limited to, diagnostics and reporting, running a script (e.g., startup or vacation mode scripts), etc. For example, a homeowner might call the bridge 230, 235 from any phone and press a key or sequence of keys to authenticate the user, and then press a key or sequence of keys (e.g., based on a menu) to execute functions (e.g., warning the security system). DTMF signals from a phone may be decoded to provide command processing.

During and after installation, the bridge 230, 235 may be remotely accessible by the installer 270 via ISP 260 or modem 265. After installation, the bridge apparatus 230, 235 may also be accessible (e.g., via computer) from a service headquarters 271 or maintenance provider 272. For example, technicians may access bridge apparatus to obtain system status, download new firmware, update the system configuration, access the stored scripts and as-built files (e.g., computer-readable program code provided at installation), and remotely control the building automation system 200. Likewise, the other service providers (e.g., security service provider 273) may also be able to access the bridge 230, 235 or the bridge 230, 235 may be able to access a service provider.

The implementations shown in FIG. 1 and FIG. 2 are provided in order to better understand various network environments in which the bridge of the present invention may be used. It should be understood, however, that the bridge apparatus may also be implemented in any of a wide range of other types and configurations of networks, now known or that may be developed in the future.

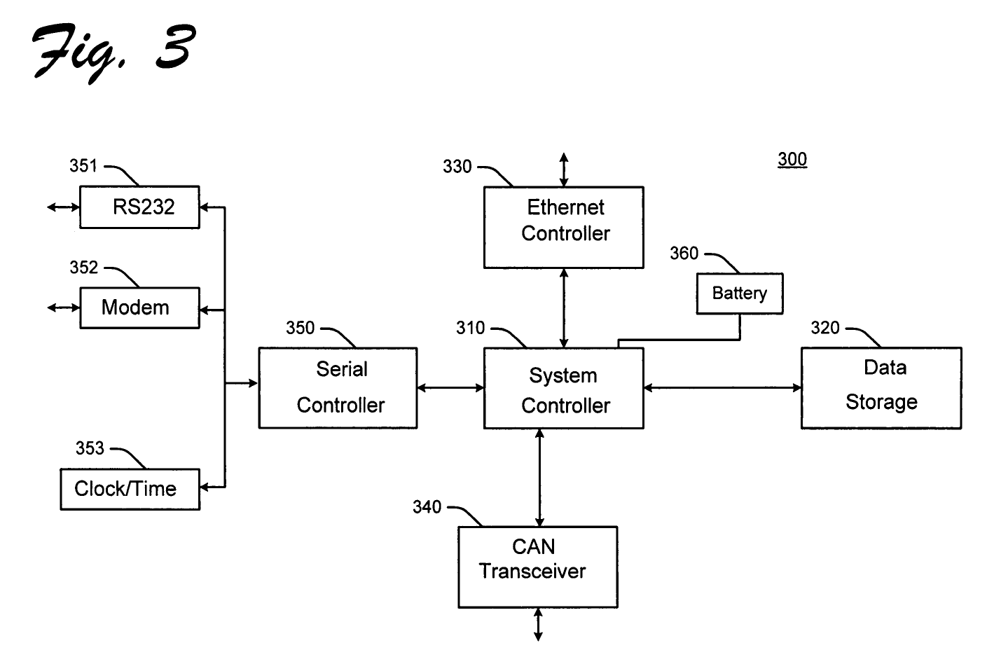

FIG. 3 is a block diagram illustrating exemplary functional blocks that may be implemented at a bridge apparatus. Bridge apparatus 300 may be used for designated functions. For example, a separate bridge apparatus 300 may be provided in a building automation system for security, and another bridge apparatus may be provided for multimedia. Alternatively, bridge apparatus 300 may be used for a plurality functions, such as, e.g., lighting, irrigation control, and multimedia.

In an exemplary implementation, the bridge apparatus 300 may include a system controller 310. The system controller 310 is used to execute program code (e.g., firmware and/or software) to implement various functions across a plurality of networks and/or busses. For purposes of illustration, the system controller 310 may receive raw weather data and filter/reformat the data so that it can be displayed at a TFT display in a building automation system. The system controller 310 may also enable remote access to the building automation system via an external source (e.g., service headquarters), execute vacation lighting mode upon user request, communicate with alarms and initiate security commands, and provide information to other devices connected to the Ethernet network, to name only a few exemplary functions.

The system controller 310 may include a commercially available embedded controller, such as a microprocessor or micro-controller. For example, the bridge may be implemented using an x86-based micro-controller (Intel Corporation; Santa Clara, Calif. 95052-8119). In an exemplary implementation, the system controller may include an x86 PC form factor called the mini-ITX, commercially available from VIA Technologies, Inc. (Fremont, Calif. 94539). The mini-ITX is a PC motherboard that is highly integrated and relatively small in size.

In another exemplary implementation, the system controller 310 may include a PIC18F458 microcontroller available from Microchip Technologies, Inc. (2355 West Chandler Blvd., Chandler, Ariz. 85224). The system controller 310 includes an embedded CAN 2.0B controller, in addition to general purpose I/O pins.

In yet another exemplary implementation, the system controller 310 may include a Tiny InterNet Interface (TINI™) platform (also referred to herein as “The DS80C400”). The DS80C400 is commercially available from Dallas Semiconductor, a subsidiary of Maxim Integrated Products, Inc. (Sunnyvale, Calif. 94086), and provides a simple, flexible and cost effective platform for designing a wide variety of hardware devices able to connect directly to corporate and home networks. The platform is a combination of a small, powerful chipset and a Java-programmable runtime environment. The chipset provides processing, control, device-level communication and networking capabilities. The features of the underlying hardware are accessible by the software developer through a set of Java application programming interfaces.

It is noted, however, that the bridge is not limited to use with any particular type of system controller 310.

The system controller 310 may be operatively associated with one or more types of computer-readable data storage 320. In an exemplary implementation, data storage 320 may include non-volatile memory and/or removable and scalable memory, although other types of computer-readable storage are also contemplated.

In an exemplary implementation, the data storage 320 may include non-volatile memory such as FLASH or battery-backed SRAM. For example, the computer-readable data storage 320 may be removable Compact Flash (CF) cards to allow easy transfer of data (e.g., if a bridge apparatus needs to be replaced). It also allows the amount of available storage to be changed by swapping out the CF card. Any size CF card may be used, such as 64MB or 2GB cards (4GB and higher should become available).

The data storage 320 may be used for storing photos of the building (exterior and/or interior), floor plans of the building, system settings, documentation of wiring layouts, system manuals, system programming, diagnostic data, subnet filter information, vacation memory, system traffic records, email and display information, label printout information, and as-built documentation, to name only a few examples.

The system controller 310 may be operatively associated with at least first and second network interfaces 330, 340. The network interfaces provide connection interfaces to other types of networks (e.g., a CAN bus and an Ethernet network). The network interfaces 330, 340 may be integrated with the system controller 310 or provided as separate components. Circuitry associated with the network connection may also be included as part of the network interfaces 330, 340 or provided separately.

The first network interface 330 may be implemented, e.g., as an Ethernet controller. The second network interface 340 may be implemented, e.g., as a CAN bus transceiver. The CAN bus transceiver provides a physical connection to a CAN bus. An exemplary implementation may also include a plurality of network interfaces, such as two Ethernet controllers and two CAN transceivers.

The system controller 310 may also be operatively associated with a serial controller 350 to provide access to devices having a serial interface. For example, the system controller 310 may be connected to RS232 serial ports 351, modems 352, a real-time clock 353, and serial EPROM's. The serial controller 350 may be provided as a separate module or integrated with the system controller 310. An exemplary implementation may include a plurality of serial controllers 350, such as three serial controllers (not shown) integrated with the system controller 310.

In an exemplary implementation, bridge apparatus 300 may be linked via an optional modem 352 for remote access. Accordingly, the bridge 300 can call out to a designated number (e.g., headquarters, security monitor), or be called (e.g., from headquarters, the user's cell phone, an Internet Service Provider). The modem 352 can connect directly to a standard telephone line. In another exemplary implementation, a second RS232 serial port can be connected to an external modem, e.g., a GPRS modem, or any device with an RS232 interface.

Bridge apparatus 300 may also include other optional components. For example, a real-time clock 353 may be operatively associated with the system controller. The clock 353 may be used to maintain date and time information for the bridge or even the entire building automation system, e.g., for scheduled maintenance, scheduled alerts or updates, etc. The clock may be synchronized with WWV time obtained via the Internet or a local WWVB receiver. Bridge apparatus 300 may also include an optional battery 360 to maintain basic functionality (e.g., date and time) even if power is removed.

The bridge apparatus 300 may include computer-readable program code to implement various functions, e.g., in the building automation system via the bridge apparatus 300. Computer-readable program code (e.g., software and/or firmware) may be stored in computer-readable storage (e.g., 320) and executed on a suitable processor or processing units (e.g., the system controller and data storage in FIG. 3). Any of a variety of readily available operating systems (e.g., Linux, Windows®, etc.) and programming languages may be used to implement functions via the bridge apparatus.

Program code may include program code for installation, maintenance, and repair of the building automation system. For example, program code may be provided for recording device identities (e.g., activated via a push button on the device) and assigning dynamic addresses to each device. Initial configuration information can be stored by the bridge apparatus so that it can be readily retrieved and used to automatically detect and configure replacement modules.

The bridge 300 may also be provided with control software. This program code may translate and transfer information between networks/busses (e.g., the CAN bus and Ethernet network). For example, bridge apparatus 300 may receive raw weather data, then filters and reformats it for distribution to other devices in the building automation system. The program code may also synchronize the clocks in the bridge apparatus 300 and/or the building automation system to WWV time (e.g., access WWV time via the Internet or a local WWVB receiver). Program code may also execute various building automation functions, such as vacation lighting, serve as a security system control point to communicate alarms and initiate commands, and serve as an irrigation system control point to communicate status and initiate commands.

In one implementation, the bridge 300 may periodically query service headquarters (or other service) for program code updates and download available updates for the bridge and/or for devices linked to the bridge. Alternatively, service headquarters may send updates to the bridge via a remote connection. In one implementation, the bridge may wait for a device to request an update, as the device may be better able to determine when an update should occur. In another implementation, however, the bridge may initiate the update.

Bridge apparatus may also include a user interface, such as a web-enable graphical user interface. Optionally, the user interface permits local and remote access and control of the bridge apparatus and devices in the building automation system. For example, the user interface may display a site home page for authorized users. The home page provides an access point to devices on the CAN bus. Alternatively, a PC or other suitable device may be connected directly to the bridge.

### Exemplary Operations

The bridge may be implemented, for example, in a building automation system for installation, operation, maintenance, and/or repair. The bridge apparatus also provides a web interface to enable features/functions of CAN bus devices, and bridging data between different types of network/bus devices (e.g., CAN and Ethernet devices).

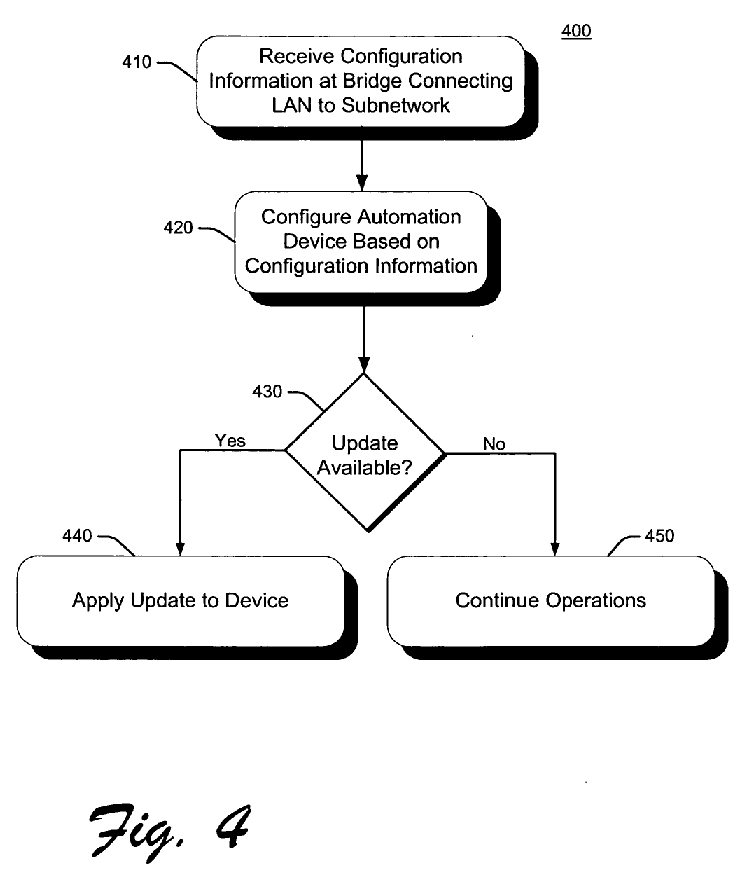

FIG. 4 illustrates exemplary operations 400 that may be implemented by the bridge apparatus. In operation 410 the bridge may receive configuration information for an automation device (e.g., program code or scripts for operating the device, data files, etc.). In operation 420, the bridge configures the automation device based on the configuration information. In operation 430, the bridge determines whether updates (e.g., firmware, program code) are available for one or more of the automation devices. For example, an update may be available from a maintenance provider. If an update is available, the bridge retrieves the update and applies it to the automation device(s) in operation 440. Otherwise, the bridge continues with operations (e.g., monitoring for updates, running various automation modes, etc.), as illustrated at 450.

Optionally, the bridge may also automatically detect if a new device has been added, removed, and replaced in a subnetwork. For example, the bridge may record device signals and assign dynamic addresses to automation devices. This information may be used to generate and maintain a map of the automation devices in the subnetwork(s). Alternatively, the bridge may store all as-built information when the system is initially configured.

In any event, when a device with a different ID is present, the bridge may determine the type of device and its configuration. For example, if a new device is the same type as a failed device and the failed device can no longer be found, the bridge may configure the device as a replacement for the failed device. If a new device is detected and there are no failed/missing devices of that type, then the bridge may configure the device as a new device. The bridge may log the event and notify the user that a new device has been installed and should be configured.

The bridge may also restore the building automation system following a power-up sequence. This operation may include reloading scripts in some or all of the devices, initializing devices, polling the devices to determine if the devices are functioning properly, etc. The bridge may restore the devices without outside intervention, e.g., using configuration information stored at the bridge. The bridge may also reset the CAN bus and the devices to a known state following a failure (e.g., AC power failure) or upon request by the user.

The bridge may also be used for monitoring the status of the building automation system. In one implementation, events are reported by the devices and the bridge may record and report events. Some events, like failures, may also be reported to service headquarters. Logged events may be reported on request and cleared based on a configuration setting (e.g., every 10 days, every month, etc.). Other status information may be obtained by periodically polling the devices. The poll rate may be configured (e.g., every hour, every day, etc.). various events. Some events (e.g., system errors) may be delivered to service headquarters, and may also be delivered to the user and the system installer, as desired. Other event notifications may also be configured by the installer and/or user.

The bridge may also be used for system administration. System administration may include setting or modifying the configuration or system information for the devices and the bridge. System information may include scripts, device IDs, email addresses, dynamic address, and building address/zip code, contact information for service headquarters, and may be stored in suitable memory operatively associated with the bridge.

The bridge may also be used for reporting and/or storing data and status information (e.g., operational and configuration data) for the building automation system. The data may be reported and/or stored in any suitable format. For example, the data may be reported via the Internet as web pages, or formatted for non-intelligent displays. In one implementation, requests for various reports are made via the Ethernet connection or via a suitable remote link (e.g., an Internet connection).

The bridge may also be used for remote access and control of devices. For example, the bridge may link an Ethernet LAN with the CAN bus and allow any remote control device linked to the LAN to control any device on the CAN bus. Exemplary remote control devices include PDAs, portable tablets, TFT displays, and PCs. In another implementation, the bridge may provide a link to the Internet, and remote control devices may be used to control devices via the Internet.

The bridge may be used to store a rolling history of system events, such as user lighting requests, which can then be played back using a “play-back mode”. Accordingly, the building appears to be “lived-in” even when the user is not present (e.g., away on vacation). A light-emitting diode (LED) may be associated with a key for activating this feature so that upon return, the user is reminded that the “playback mode” is on and turn it off.

Additionally, the user may schedule the “playback mode” to occur during a predetermined time (e.g., begin on a leave date and stop on a return date). Preferably, the user may access the bridge from outside the building to activate or deactivate the “play-back mode.” Other functions (e.g., HVAC controls, water heater temperature, etc.) may also be operated with the “playback mode”, and can be configured for different events at predetermined times. For example, the HVAC system may automatically return to a daily routine upon return from vacation.

### Exemplary Computing Device

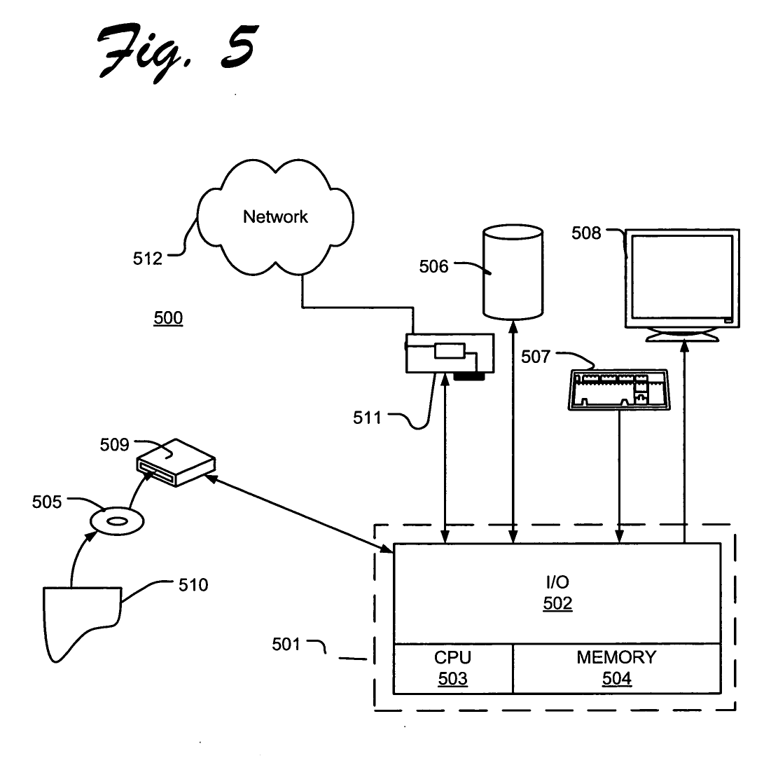

FIG. 5 depicts an exemplary general purpose computer 500 capable of executing a program product and establishing a secure authenticated network connection. In such a system, data and program files may be input to the computer, including without limitation by removable or non-removable storage media or a data signal propagated on a carrier wave (e.g., data packets over a network). The computer 500 may be a conventional computer, a distributed computer, or any other type of computing device.

The computer 500 can read data and program files, and execute the programs and access the data stored in the files. Some of the elements of an exemplary general purpose computer are shown in FIG. 5, including a processor 501 having an input/output (I/O) section 502, at least one processing unit 503 (e.g., a microprocessor or microcontroller), and a memory section 504. The memory section 504 may also be referred to as simply memory, and may include without limitation read only memory (ROM) and random access memory (RAM).

A basic input/output system (BIOS), containing the basic routines that help to transfer information between elements within the computer 500, such as during start-up, may be stored in memory 504. The described computer program product may optionally be implemented in software modules loaded in memory 504 and/or stored on a configured CD-ROM 505 or other storage unit 506, thereby transforming the computer system in FIG. 5 to a special purpose machine for implementing the described system.

The I/O section 502 is optionally connected to keyboard 507, display unit 508, disk storage unit 506, and disk drive unit 509, typically by means of a system or peripheral bus (not shown), although it is not limited to these devices. The system bus may be any of several types of bus structures including a memory bus or memory controller, a peripheral bus, and a local bus using any of a variety of bus architectures.

Typically the disk drive unit 509 is a CD-ROM drive unit capable of reading the CD-ROM medium 505, which typically contains programs 510 and data. Computer program products containing mechanisms to effectuate the systems and methods in accordance with the present invention may reside in the memory section 504, on a disk storage unit 506, or on the CD-ROM medium 505 of such a system. Alternatively, disk drive unit 509 may be replaced or supplemented by a floppy drive unit, a tape drive unit, or other storage medium drive unit. The network adapter 511 is capable of connecting the computer system to a network 512. In accordance with the present invention, software instructions directed toward accepting and relaying access information (e.g., authentication and security data) may be executed by CPU 503, and databases may be stored on disk storage unit 506, disk drive unit 509 or other storage medium units coupled to the system.

The drives and their associated computer-readable media provide nonvolatile storage of computer-readable instructions, data structures, program modules and other data for the computer 500. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

The computer 500 may operate in a networked environment using logical connections to one or more remote computers. These logical connections are achieved by a communication device 511 (e.g., such as a network adapter or modem) coupled to or incorporated as a part of the computer 500. Of course the described system is not limited to a particular type of communications device. Exemplary logical connections include without limitation a local-area network (LAN) and a wide-area network (WAN). Such networking environments are commonplace in office networks, enterprise-wide computer networks, intranets and the Internal, which are all exemplary types of networks.

In addition to the specific implementations explicitly set forth herein, other aspects and implementations will be apparent to those skilled in the art from consideration of the specification disclosed herein. It is intended that the specification and illustrated implementations be considered as examples only, with a true scope and spirit of the following claims.

What is claimed is:

1. A bridge apparatus for a building automation system comprising:
a system controller;
a first network controller operatively associated with the system controller, the first network controller connecting the bridge to a local area network;
a second network controller operatively associated with the system controller, the second network controller connecting the bridge to a subnetwork; and
computer-readable program code provided in computer-readable storage operatively associated with the system controller, the computer-readable program code including:
program code for receiving configuration information via the local area network; and
program code for configuring an automation device connected to the subnetwork based on the configuration information.

2. The bridge apparatus of claim 1, wherein the computer-readable program code further includes program code for assigning a dynamic address to the automation device in the subnetwork.

3. The bridge apparatus of claim 1, wherein the computer-readable program code further includes program code for receiving updated configuration information via the local area network for the automation device in the subnetwork.

4. The bridge apparatus of claim 1, wherein the computer-readable program code further includes program code for maintaining a map of automation devices in the subnetwork.

5. The bridge apparatus of claim 1, wherein the computer-readable program code further includes program code for automatically updating the map if an automation device is added to the subnetwork.

6. The bridge apparatus of claim 1, wherein the computer-readable program code further includes program code for operating automation devices in a vacation mode.

7. The bridge apparatus of claim 1, wherein the computer-readable program code further includes program code for updating firmware at the device in the subnetwork.

8. The bridge apparatus of claim 1, wherein the computer-readable program code further includes program code for resetting a device in the subnetwork.

9. A building automation system comprising:
a local area network;
a subnetwork for connecting at least one automation device;
a first bridge connecting the subnetwork to the local area network;
a second bridge connecting the subnetwork to the local area network,
wherein at least one of the bridges connects the subnetwork to the local area network even if the other bridge is offline.

10. The building automation system of claim 9, wherein at least one of the bridges is communicatively coupled to at least one automation device even if the subnetwork includes a break.

11. The building automation network of claim 9, wherein the subnetwork is a CAN bus.

12. The building automation network of claim 9, wherein the local area network is an Ethernet network.

13. The building automation network of claim 9, further comprising a plurality of subnetworks connected to the local area network by a plurality of bridges.

14. A method comprising:
connecting a bridge to a local area network;
connecting the bridge to a subnetwork;
receiving configuration information at the bridge via the local area network; and
configuring an automation device in the subnetwork based on the configuration information received at the bridge.

15. The method of claim 14, further comprising assigning a dynamic address to the automation device in the subnetwork.

16. The method of claim 14, further comprising receiving updated configuration information via the local area network for the automation device in the subnetwork.

17. The method of claim 14, further comprising maintaining a map of automation devices in the subnetwork.

18. The method of claim 14, further comprising automatically updating a map of automation devices in the subnetwork if an automation device is added to the subnetwork.

19. The method of claim 14, further comprising operating automation devices in a vacation mode.

20. The method of claim 14, further comprising resetting a device in the subnetwork.

21. The method of claim 14, further comprising isolation of a fault in the subnetwork.

22. The method of claim 14, further comprising automatic rerouting of subnetwork traffic if a subnetwork fails.
